(19) United States
(12) Patent Application Publication
(10) Pub. No.: US 2023/0312420 A1
(43) Pub. Date: Oct. 5, 2023

(54) THIN RADIATION REFLECTING DRY POLYMER MODIFIED CEMENT OVERLAY FOR COOLING UNDERLYING SUBSTRATES

(71) Applicant: W. Robert Wilson, Boonton, NJ (US)

(72) Inventor: W. Robert Wilson, Boonton, NJ (US)

(21) Appl. No.: 17/893,055

(22) Filed: Aug. 22, 2022

Related U.S. Application Data
(60) Provisional application No. 63/235,244, filed on Aug. 20, 2021.

(51) Int. Cl. C04B 28/04; C04B 16/04; C04B 14/22

(52) U.S. Cl. CPC C04B 28/04; C04B 16/04; C04B 14/22; C04B 2103/54

(57) ABSTRACT

Substrates (e.g., roadways, roofs, walkways) that absorb suns radiation may be undesirably hot (e.g., too hot to use, increased energy costs). Radiation reflecting colored substrates may reduce temperature, but may be impractical (e.g., thickness, use). Radiation reflecting colored coatings (e.g., paints, thermoplastics, polymer coatings, tape) applied on substrate may reduce temperature but have limited lifecycles (e.g., worn off, peel off, lose their color over time). A radiation reflecting colored dry polymer modified cement mixture may be applied as a thin overlay (e.g., thicknesses of approximately ⅛^{th} inch, thickness between 1/75^{th} to 1/16^{th} inch) on the substrate to provide a long-lasting solution for reducing temperature. The dry polymer modified cement mixture is prepared by mixing a dry polymer modified cement blend (ordinary Portland cement, aggregate, polymer powders and pigments) with water. Pigments reduce absorption of radiation including infrared wavelengths and are not limited to lighter colors in visible spectrum of light.

### BACKGROUND

Radiation from the sun that reaches the earth's surface can be divided into three parts including ultraviolet (UV), visible and infrared (IR). The visible wavelengths and to some degree the UV wavelengths account for the color that is seen. Each of the three parts accounts for a portion of the suns radiation that reaches the earth. The radiation associated with the UV wavelengths is a small amount (approximately 3-5%) while the radiation of the visible wavelengths (approximately 44-50%) and the IR wavelengths (approximately 45-53%) each account for a substantial portion. The more of the suns radiation that is absorbed by a substrate may result in an increased temperature thereof. The increased temperature of the substrate may not be desirable. For example, if the substrate was a walkway the increased temperature may make in unbearable for humans or animals to walk on it. If the substrate was a roof of a building the increased temperature may result in increased energy costs to cool the building.

It may be desirable to decrease the temperature of different substrates (e.g., buildings, roads, bridges, parking lots) for energy savings, substrate preservation, and overall planet cooling. One way to keep substrates cooler is to utilize colors for the substrate that reflect the suns radiation rather than colors that absorb the suns radiation. One skilled in the art would recognize that for the visible spectrum of light, that lighter colors reflect more radiation and darker colors absorb more radiation. Theoretically, white reflects all the radiation and black absorbs all the radiation.

Making the surfaces a lighter color may require pigment to be added to the substrate to change the color thereof. Depending on the thickness of the substrate this may not be practical. Alternatively, the surface of the substrate may be provided with a coating having a lighter color. The coating may be, for example, paints, thermoplastics, polymer coatings (e.g., epoxy), and tape (e.g., thermoplastic, polymer). The various coatings may have limited lifecycles in that, for example, they may be worn off, peel off, or lose their color over time. The coatings may, for example, be susceptible to environmental conditions including, but not limited to, ultra-violet light, condensation (e.g., snow, rain, ocean water), wind and/or temperature swings. For certain substrates, such as roads and walkways, the wear and tear of being traversed by, for example, vehicles and/or pedestrians may result in deterioration of the coatings and/or the underlying substrate. Moreover, in certain geographic areas the roads and walkways may get covered with snow or ice and require the use of a plow to remove the snow and possibly damage the coatings and/or the underlying substrate.

Furthermore, the various coatings may be thermally incompatible with the underlying substrate. The thermal incompatibility means that the dimensional properties of the coating changes at different rates than the substrate they are applied to which may result in delamination of the coating from the substrate or damage to the substrate. In addition, the properties of the various coatings may change with age (e.g., steric hardening, loss of volatiles) resulting in degradation thereof.

Additionally, while substrates having a light color may reflect the sun's radiation in the visible light spectrum and keep the substrate cooler, they may not be desirable for certain substrates. For example, the light color may not be as aesthetically pleasing as more vibrant colors. Moreover, the lighter colors may be more suspectable to discoloration as stains, dirt and the like are more visible.

What is needed is a coating having a longer life expectancy than typical coatings that will stay secured to substrate, maintain its color and not damage the underlying substrate. Furthermore, what is needed is a coating that includes more vibrant colors in the visible wavelengths and thus absorb more visible radiation but that reflect the IR wavelengths so that the more vibrant colors provide a cooling effect.

### DETAILED DESCRIPTION

Polymer modified cements are cement blends (e.g., concrete, mortar) that include the addition of the polymers to, for example, increase flexibility, increase workability, increase bond with underlying substrate and/or form a tough and long-wearing surface. Polymer modified cements may be designed to be applied to substates (concrete, asphalt) as thin overlays. The substrates may be, for example, roads, parking lots, driveways, paths (e.g., walking, biking, hiking), verticals and/or roofs. Preferred polymer modified cements used as thin overlays have excellent initial and long-term bond to the substrates. Preferred polymer modified cements do not soften at elevated temperatures or embrittle at lower temperatures. Preferred polymer modified cements provide an overlay that is resistant to traffic and weathering and has a long-life expectancy. Preferred polymer modified cements may also act as an adhesive layer (similar to epoxy, polyurethane, and bitumen) where prior to curing objects (e.g., aggregate for providing friction, glass beads to enhance visibility at night by retroreflecting automotive headlights) may be received therein and then once cured the objects are secured therewithin.

The polymer modified cements may include pigments for providing color to the substrate. In a preferred embodiment, the pigments utilized will reflect a sufficient amount of the suns radiation to provide a cooler substrate. The pigments may be lighter colors in the visible spectrum which reflect more of the radiation in the visible spectrum than darker colors in the visible spectrum. The pigments may be colors that are darker and more vibrant in the visible spectrum but that reflect more of the radiation in the IR spectrum. According to one embodiment, the pigments may provide reflection in both the visible and IR spectrum. As the polymer modified cements may be applied as a thin overlay on top of the substrate the amount of pigment that is required to adequately color the substrate with the overlay is much less than if the substrate itself was colored.

Cement blends typically include cement (e.g., ordinary Portland cement), aggregate and possibly other materials (e.g., microfibers, plasticizer, filler, accelerator, retarder). The polymers used in the polymer modified cements may be, for example, dry polymers (e.g., polymer powders). The dry polymers may be mixed with the cement blend to create a dry polymer modified cement blend. The dry polymer modified cement blend is mixed with water and then the dry polymer modified cement mixture is applied to the desired location. The use of a dry polymer improves the quality control during the mixing of the product on site as the dry polymer modified cement blend may be delivered to the site and simply require the addition of water which simplifies the mixing and placing operation on site. The dry polymer modified cements will not typically have some of the issues associated with wet polymer modified cements (e.g., air voids, surface tension cracks).

The dry polymers may be redispersible binders. According to one embodiment, the redispersible binders may be based on a copolymer of vinyl acetate and ethylene. The redispersible polymer may also include defoaming and self-leveling properties to assist with the reduction of air during the mixing process that is common when wet polymers are mixed with cement blends. The reduction of air improves the impermeability of the surface mix and increases the abrasion resistance of the cured material.

The aggregate typically used in cement blends, as well as dry polymer modified cement blends, is sand or other aggregate having gradations that meet the ASTM C144 specification. The aggregate is used to provide layer thickness, to improve mixing, limit segregation and may provide a rough surface that can increase skid resistance. Using aggregate gradations that meet the ASTM C144 specification provides a gradation that is intended to consume a moderate quantity of cement, produces a wet mix that is workable without having to use too much water or additives, does not shrink excessively, and cures at an appropriate rate to allow a bond to develop with the underlying substrate. Using aggregate gradations that meet the ASTM C144 specification produces, after mixing the blend with water, a dry polymer modified cement mixture that may be applied to an underlying substate as a relatively thin layer (e.g., thicknesses of up to approximately ⅛ in (3 mm)).

It was believed that aggregate having a finer gradation than ASTM C144 specification would consume too much cement and require too much water as the surface area of the aggregate is increased. However, using aggregate with finer gradations than the ASTM C144 specification (ultrafine aggregate) actually provides a dry polymer modified cement mixture that can be applied even thinner (and thus not consume additional cement) and also enables objects (e.g., topical aggregate, glass beads) to be received thereby easier and be secured therein better. The ultrafine aggregate may be any semi gap graded material with a D₈₀ of less than 300 microns and a D₄₀ of less than 200 microns. According to one embodiment, the ultrafine aggregate may be marble dust. A dry polymer modified cement mixture using ultrafine aggregate may be applied to an underlying substate at thicknesses between 1/75^{th} inch (0.3 mm) to 1/16^{th} inch (1.5 mm).

According to one embodiment, the dry polymer modified cement mixture may also include microfibers to limit segregation, shrinkage and exothermal generation. The microfibers may be natural or synthetic. The microfibers may have a length of up to approximately 1 inch.

According to one embodiment, the dry polymer modified cement mixture may also include additives. The additives may include, for example, a plasticizer to increase workability. The additives may include a filler, such as a pozzolanic filler, to increase workability, limit segregation and shrinkage and increase long term compressive strength. The filler may be fly ash, such as class C or class F fly ash. The additives may include, for example, an accelerator to increase curing process that may be needed for nighttime applications and time sensitive applications. The additives may include, for example, a retarder along with the accelerator to delay the change in workability that comes from adding the accelerator.

The base color of the cement is a light color (e.g., white) and the base color of the aggregate (e.g., marble dust) may also be a light color (e.g., white). Accordingly, the starting color of the dry polymer modified cement mixture is a light color which increases effectiveness of reflecting visible spectrum of solar radiation. The base colors of the cement and aggregate do not fade so the light color should not fade or wear over time. However, the dry polymer modified cement mixture may include pigments to provide an appropriate color for the desired use thereof and appropriate reflection of the suns radiation to provide a cooler substrate. The pigment may make the dry polymer modified cement visibly whiter and brighter or may provide a more vibrant and darker color that reflects the infrared radiation. As the thin overlay is colored throughout, the color retention of the dry polymer modified cement is excellent. Accordingly, it is possible to use pigments that are more costly due to the brightness of the colors and/or the ability of the pigments to limit the absorption of infrared light. That is, pigments may be provided that limit the absorption of IR radiation that are not the lighter colors normally associated with reflecting visible light.

According to one embodiment, the dry polymer modified cement mixture may be the same or similar to the dry polymer cement overlay described in U.S. Pat. No. 8,784,557 which is herein incorporated by reference. According to one embodiment, the dry polymer cement may use different versions for at least some of the various ingredients described therein (e.g., may use different dry polymers than the Elotex® polymers noted therein, aggregate may be ultrafine aggregate), may use different ratios for at least some of the ingredients, may replace certain ingredients, may add ingredients thereto, may delete ingredients therefrom, may use a single ingredient in place of a combination of different ingredients and/or may use a combination of different ingredients instead of a single ingredient. The ingredients and the ratios may depend on the specific application of the dry polymer cement overlay.

According to one embodiment, the dry polymer modified cement may be the Endurablend® or Enduramark® products provided by Pavement Surface Coatings, LLC, a New Jersey Corporation.

The dry polymer modified cement blend may be delivered to the site with all the necessary elements mixed together at the appropriate proportions for the job at hand. The dry polymer modified cement mixture may be prepared by mixing an appropriate amount of dry polymer modified cement blend with an appropriate amount of water. According to one embodiment, the dry polymer modified cement blend may me mixed with cold water or ice may be added with the water to increase the workability of the mixture. The dry polymer modified cement mixture may be applied to the substrate using standard processes, such as screeding or spraying. The dry polymer modified cement mixture is applied wet to the surface so that it ensures an excellent initial and long-term bond.

The dry polymer modified cement mixture may be prepared and provided to a vehicle capable of applying to the substrate. Alternatively, the vehicle may be capable of housing and mixing the polymer modified cement blend and the water to create the polymer modified cement mixture. The vehicle may include one or more nozzles that can be activated to spray the dry polymer modified cement mixture onto the substrate.

The dry polymer modified cement mixture may be applied as a thin overlay in line with the thickness of the paints, thermoplastics, polymer coatings (e.g., epoxy), and tape (e.g., thermoplastic, polymer) commonly used for providing color to a substrate when it is impractical to color the substrate itself.

The dry polymer modified cement colored overlay may be applied over both asphaltic and concrete surfaces, including sealcoats; single chip, double chip or cape seals; all asphalt slurry types; all asphalt microsurfacings, thin hot mix flexible asphalt pavement surfaces with high surface deflections (≥0.8 mm deflection); thick hot mix flexible asphalt pavement surfaces with low surface deflections (≥0.8 mm deflection); all Portland cement concrete pavements; roller compacted concrete; and whitetopping. The dry polymer modified cement colored overlay may be applied on smooth, textured and porous surfaces.

According to one embodiment, the dry polymer modified cement colored overlay may have different items embedded therein prior to the overlay curing. According to one embodiment, aggregate may be embedded therein to provide a friction surface. According to one embodiment, glass beads may be embedded therein to enhance visibility at night by retroreflecting light being shined thereat (e.g., headlights of a car driving on a road at night). The various items that may be embedded into the dry polymer modified cement colored overlay may be embedded over the entire dry polymer modified cement colored overlay or just portions thereof depending on the purpose of the embedded items (what is being accomplished by the embedded items). The items may be embedded by dropping and/or broadcasting the items onto the overlay. The items may be dropped/broadcast soon after the overlay is applied. The items may be dropped/broadcast manually or using a piece of equipment. The equipment may extend over the overlay and provide the ability to drop/broadcast the items thereon. The equipment may be the same equipment that applied the overlay and provides the ability to drop/broadcast following the application.

According to one embodiment, the dry polymer modified cement colored overlay may be patterned (provide grout lines to define desired patterns). Various patterns (e.g., square, rectangle, triangle, hexagon) may be formed in the dry polymer modified cement colored overlay. The patterns may be utilized for various reasons including, but not limited to, aesthetics, water runoff, and limit continuous amount of surface area where the two layers overlap to reduce the effect of the thermal incompatibility between the layers. According to one embodiment, a hexagon shape may provide the best limitation on continuous overlap between the overlay and the substrate). The thermal incompatibility may lead to the layers flexing, expanding and the like at different times and to different degrees which may cause delamination of the overlay from the underlying substrate and/or damage to the overlay and/or underlying substrate. Any thermally developed strain that may build up between an overlay pattern and the underlying substrate may be relieved at the location of the grout lines.

The overlay patterns may be formed by using stencils. The stencils may be pre-manufactured to produce the desired pattern shape, size and thickness. The stencils may be made from, for example, paper, metallic materials, plastic, synthetic materials or some combination thereof. The shapes, size and thickness of the patterns (shapes formed within the overlay) may be dictated based on, for example, the look desired and the primary use of the overlay. The stencils may be provided on the substrate, the dry polymer modified cement colored mixture may be applied as a thin overlay on the substrate and stencils and then the stencils may be removed thus providing a patterned dry polymer modified cement colored overlay.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

1. A method for reducing absorption of solar radiation by a substrate, the method comprising:
preparing a dry polymer modified colored cement mixture by mixing a dry polymer modified colored cement blend with water, wherein the dry polymer modified colored cement blend includes ordinary Portland cement, aggregate, polymer powders and pigments, wherein at least a portion of the pigments are to reduce the absorption of the solar radiation including infrared wavelengths, wherein the at least a portion of the pigments are not limited to lighter colors in visible spectrum of light; and
applying the dry polymer modified colored cement mixture as a thin overlay onto the substrate, wherein the thin overlay has a thicknesses of approximately ⅛^{th} inch (3 mm) or less.

2. The method of claim 1, wherein the substrate is a trafficked pavement substrate.

3. The method of claim 1, wherein the substrate is a roof.

4. The method of claim 1, wherein the substrate is a vertical.

5. The method of claim 1, wherein the polymer powders are redispersible binders based on a copolymer of vinyl acetate and ethylene.

6. The method of claim 1, wherein the aggregate is an ultrafine aggregate including any semi gap graded material with a D₈₀ of less than 300 microns and a D₄₀ of less than 200 microns.

7. The method of claim 6, wherein thin overlay has a thicknesses between 1175th inch (0.3 mm) to 1/16^{th} inch (1.5 mm).

8. The method of claim 1, wherein the dry polymer modified colored cement blend further includes microfibers to limit segregation, shrinkage and exothermal generation and improve workability.

9. The method of claim 1, wherein the applying the dry polymer modified colored cement mixture includes spraying the dry polymer modified colored cement mixture onto the substrate.

10. The method of claim 1, further comprising providing items into the dry polymer modified colored cement mixture applied to the substrate before the dry polymer modified colored cement mixture is cured.

11. The method of claim 10, wherein items include aggregate to provide a friction surface or glass beads to enhance visibility at night by retroreflecting light.

12. The method of claim 1, wherein the applying the dry polymer modified colored cement mixture includes applying the dry polymer modified colored cement mixture in a pattern.

13. A dry polymer modified colored cement mixture to be applied as a thin overlay on a substrate, wherein the thin overlay has a thicknesses of approximately ⅛^{th} inch (3 mm) or less and is to reduce absorption of solar radiation by the substrate, the mixture comprising:
a dry polymer modified colored cement blend mixed with water, wherein the dry polymer modified colored cement blend includes ordinary Portland cement, aggregate, polymer powders and pigments, wherein at least a portion of the pigments are to reduce the absorption of the solar radiation including infrared wavelengths and are not limited to lighter colors in visible spectrum of light.

14. The mixture of claim 13, wherein the substrate is a trafficked pavement substrate, a roof or a vertical.

15. The mixture of claim 13, wherein the polymer powders are redispersible binders based on a copolymer of vinyl acetate and ethylene.

16. The mixture of claim 13, wherein the aggregate is an ultrafine aggregate including any semi gap graded material with a D₈₀ of less than 300 microns and a D₄₀ of less than 200 microns, and wherein the thin overlay has a thicknesses of between 1/75^{th} inch (0.3 mm) to 1/16^{th} inch (1.5 mm).

17. The mixture of claim 13, wherein the dry polymer modified colored cement blend further includes microfibers to limit segregation, shrinkage and exothermal generation and improve workability.

18. The mixture of claim 13, wherein the dry polymer modified colored cement mixture includes items applied thereto after the dry polymer modified colored cement mixture is applied to the substrate but before the dry polymer modified colored cement mixture is cured.

19. The mixture of claim 18, wherein the items include aggregate to provide a friction surface or glass beads to enhance visibility at night by retroreflecting light.

20. The mixture of claim 13, wherein the dry polymer modified colored cement mixture is applied to the substrate in a pattern.
